(19) United States
(12) Patent Application Publication
(10) Pub. No.: US 2008/0283774 A1
(43) Pub. Date: Nov. 20, 2008

(54) ELECTRICALLY-CONTROLLED WINDOW TINTS

(76) Inventors: Fredel Williamson, Decatur, GA (US); Carlton Williamson, Decatur, GA (US)

Correspondence Address: Fredel Williamson, 3104 Waldrop Place, Bldg. #3, Decatur, GA, 30034, US

(21) Appl. No.: 11/749,388

(22) Filed: May 16, 2007

(51) Int. Cl. H05B 33/12; H05B 33/14; H05B 33/18

(52) U.S. Cl. 250/484.2

(57) ABSTRACT

The present invention relates to a window-tinting device. The window-tinting device includes two sheets of glass. These sheets of glass form an airtight interchamber. Within the chamber there is mixture of chemicals. A variable inductor and a frequency oscillator are placed in series and are electrically connected to the interchamber. The frequency oscillator and the inductor are controlled remotely transmit various frequencies of radiation into the interchamber. The radiation ionizes the chemicals and transforms the chemicals into controllable visible light. The visible light may take on any number of colors, shapes and/or patterns.

### BACKGROUND OF THE INVENTION

1. Field of the Invention

The present invention relates to tinted windows. Specifically, the present invention relates to tinted windows that have the ability to change color and/or patterns.

2. Prior Art

In order to protect privacy and screen light, the prior art coated a special polarizing film onto a transparent glass-paned window so that viewing a room or vehicle from the outside can not be easily observed. The polarizing film applied to the glass-paned window includes, for example, film obtained by coating a transparent substrate such as polyester film and polyolefin film with ink containing powders of a metal. Using the above polarizing film, when the scene inside is observed from the outside, the glass-paned window appears to have a gray or similar halftone color and the situation inside can not be observed. This is because only a brightness of the outside of the glass-paned window is reflected by a polarizing function of the film. Inside of the glass-paned window, the outside scene can be seen similar to the case where the polarizing film is not used, and the view is not obstructed.

Recently, electrochromic windows have been developed where the windows can block the glare of the sun with the flip of a switch. Electrochromic windows are part of a new generation of technologies called switchable glazing or “smart” windows. Switchable glazing can change the light transmittance, transparency, or shading of windows in response to an environmental signal such as sunlight, temperature or an electrical control. Electrochromic windows change from transparent to tinted by applying an electrical current. Potential uses for electrochromic technology include daylighting control, glare control, solar heat control, and fading protection in windows and skylights. By automatically controlling the amount of light and solar energy that can pass through the window, electrochromic windows can help save energy in residences.

A variety of electrochromic technologies and media have been developed. One type of window is darkened by applying a small electrical voltage to the windows and lightened by reversing the voltage. Light transmittance during operation varies from five to 80 percent. Once the change in tint has been initiated, the electrochromic glazing has “memory” and does not need constant voltage to maintain the tinting. Further, the film can be tuned to block certain wavelengths, such as infrared (heat) energy.

Another switchable technology, the liquid crystal suspended particle device (SPD), contains molecular particles suspended in a solution between plates of glass. In their natural state, the particles move randomly and collide, blocking the direct passage of light. When energized, the particles align rapidly and the glazing becomes transparent. This type of switchable glazing can block up to about 90 percent of light.

There are also residential windows that have a liquid crystal glazing that switches from clear to milky white. Although the windows do not significantly reduce the amount of light transmission, they provide privacy by reducing transparency. This type of glazing requires a steady current to keep the glass in the clear state.

Another tinting system involves coating a window with five layers of ceramic materials, which have a total thickness that is less than 1/50th that of a human hair. When voltage is applied across the coatings, ions travel from one layer to another layer, where a reversible solid-state change takes place, causing the coating to tint and absorb light. Reversing the polarity of the applied voltage causes the ions to migrate back to their original layer, and the glass returns to its clear state.

There is significant commercial interest in the fabrication of glass windows that have a tint-switching technology. But further improved compositions and methods are needed to enhance the characteristics of windows.

### SUMMARY OF THE INVENTION

The present invention enhances the characteristics of window-tints by providing an electrically-controlled tinting device that controls the color and/or pattern of a tint and changes those colors and/or patterns when desired.

The device includes two sheets of glass that are each about 1/16″ to about ¼″ in thickness. These sheets form an ultra-thin interchamber therebetween. The interchamber is filled with a mixture of chemicals.

A variable inductor and a frequency oscillator are electrically connected in series to the interchamber. The frequency oscillator and the inductor control the amount and frequency of radiation within the interchamber thereby transforming the chemicals into controllable visible light. That is, the interchamber acts as a fluorescent screen and when the mixture of phosphors are impinged by the radiation the phosphors glow.

A plurality of radiation sequences may be used, with each sequence being controlled by a separate inductor, which in turn is controlled by a single oscillator. The radiation is a frequency of X-rays and/or gamma rays. And since various types of gases interact with the different frequencies of radiation, the window tint is controlled to give the window different colors, tints, tones, shades and frosts.

Applications for the present invention include, but are not limited to, automobiles, heavy-wheeled vehicles, motorcycles, boats, aircrafts, office buildings and residential houses.

### BRIEF DESCRIPTION OF THE DRAWINGS

These and other features, aspects, and advantages of the apparatus and methods of the present invention will become better understood with regard to the following description and accompanying drawings where:

FIG. 1 is a block diagram of the preferred embodiment of the present invention;

FIG. 2 is a top view of the preferred embodiment of the present invention; and

FIG. 3 is a block diagram of a second preferred embodiment of the present invention.

### DETAILED DESCRIPTION OF THE INVENTION

The present invention enhances the characteristics of window-tints by providing an electrically-controlled tinting device that can control the color and pattern of window tint and changes those colors and patterns when desired.

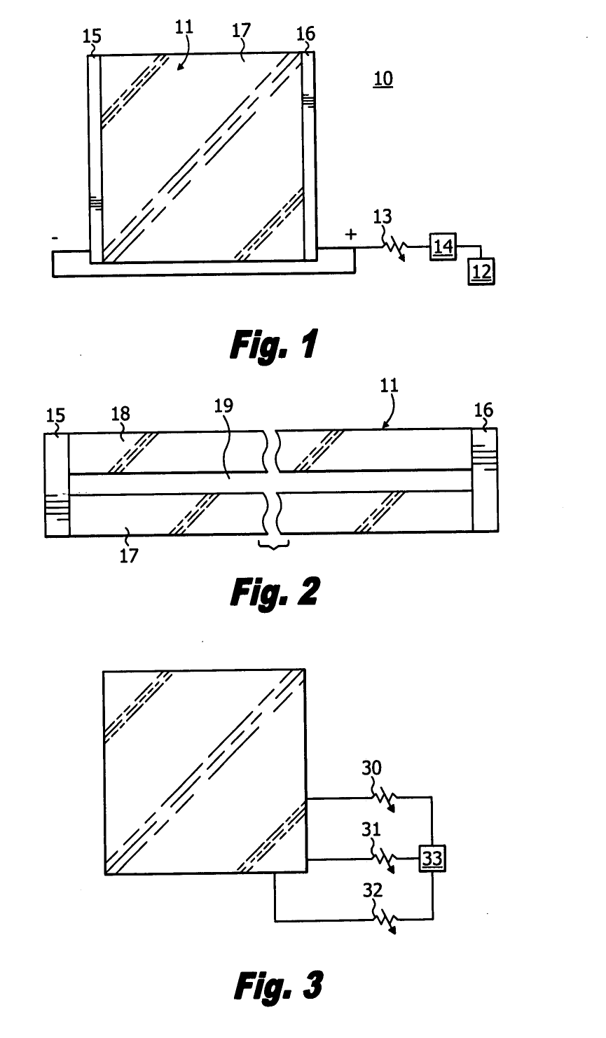

In FIGS. 1 and 2, the device 10 includes a window 11 formed from two sheets of glass 17, 18 that are each about 1/16″ to about ¼″ in thickness. The sheets 17, 18 form an ultra-thin (about 0.1 to 20 mils) interchamber 19 therebetween. The interchamber 19 is filled with a mixture of chemicals and is sealed airtight by seals 15, 16 at a very low pressure.

The mixture of chemicals may include gases of various parts per billion sealed within the interchamber 19. Composition of many gases is possible as to create color and density. For example, the mixture may contain nitrogen gas, a liquid mixture of phosphors and an oxygen moisturizer.

Phosphors are chemicals that absorb radiant energy of a given wavelength and reradiate at longer wavelengths through a process of phosphorescence thereby producing visible light when excited with ultra-violet (UV) radiation. Phosphorous occurs in a variety of allotropic forms, including the familiar highly reflective white form and a much less reactive red form and a black modification that will appear to be the most stable form. Alternately, the inside of the glass may have a phosphor coating instead of the liquid mixture.

Nitrogen is a gas that liquefies at roughly 200 degrees C. and is colorless both as a gas and as a liquid. Nitrogen is well known as a UV-emitter because of its 2nd positive band lying around 350 nm. However, it is a molecular gas and when energy is stored in rotational or vibrational levels, the gas temperature can become high enough to melt even the glass tube. So care must be taken not to increase the temperature to unsafe levels and to better control the discharge of the nitrogen an oxygen moisturizer is added to the mixture.

A variable inductor 13 and a frequency oscillator 14 are electrically connected in series to the interchamber 19 at a pair of electrodes at each end of the window. The electrodes are sealed along the window inside the interchamber. The frequency oscillator 14 and the inductor 13 control the radiation within the interchamber 19 thereby transforming the chemicals into controllable visible light through ionization. Ionization is the removal of electrons from an atom, for example, by means of radiation, so that the atom becomes charged.

The radiation is produced from an oscillator 14. The oscillator 14 may produce any numbers of X-rays and/or gamma rays in multiple frequency ranges. And because various types of gases interact with different radiation frequencies the mixture of chemicals changes colors, tints, tones, shades and frosts depending on (1) the chemical composition within the interchamber 19 and (2) the frequencies of the radiation. Thus, the window 11 is able to display visible light which creates illusions of color and patterns. The advantage of the display is that a user is not able to see from outside in but is able to see from the inside out due to the brightness which is reflected away from the window 11.

In use, the nitrogen gas acts as a fluorescent screen for the mixture of phosphors when the phosphors are impinged by the radiation. The phosphors form an image of color and different tinted shades, both of which are controlled by the electric discharge of the inductor 13 and oscillator 14.

Specifically, the main principle of the present invention is based around inelastic scattering of electrons. An incident electron emitted from the oscillator collides with an atom in the chemical mixture. This causes an electron in the atom to temporarily jump up to a higher energy level to absorb some, or all, of the kinetic energy delivered by the colliding electron. This higher energy state is unstable, and the atom will emit an ultraviolet photon as the atom's electron reverts to a lower, more stable, energy level. The photons that are released from the chosen gas mixtures tend to have a wavelength in the ultraviolet part of the spectrum. This is not visible to the human eye, so must be converted into visible light. This is done by making use of fluorescence. The fluorescent conversion occurs in the mixture of phosphors within the interchamber. The ultraviolet photons are absorbed by electrons in the phosphor's atoms, causing a similar energy Jump, then drop, with emission of a further photon. The photon that is emitted from this second interaction has a lower energy than the one that caused it. Simply, when the mixture of phosphors are impinged by the radiation, the phosphors glow. The chemicals that make up the phosphor are specially chosen so that these emitted photons are at wavelengths visible to the human eye. The difference in energy between the absorbed ultra-violet photon and the emitted visible light photon goes to heat up the phosphors.

When power is first applied, a high voltage (several hundred volts) is needed to initiate the discharge. However, once this takes place, a much lower voltage is needed to maintain it. If high voltages were constantly used, the window would rapidly self-destruct due to the unlimited current flow. To prevent this, the variable inductor is used to regulate the current flow through the window. A computer system (not shown) may also be connected to the inductor so that a computer program may control the current flow and frequencies so that a limitless amount of color and/or patterns may be achieved.

In another embodiment, a plurality of frequencies are used to change the color and pattern of the tint. If several frequencies are used, as shown in FIG. 3, each radiation sequence may be controlled by a separate inductor 30-32 and each inductor may be controlled by a single oscillator 33. Or each inductor may have a separate oscillator (not shown).

Applications for the present invention include, but are not limited to, windows for automobiles, heavy-wheeled vehicles, motorcycles, boats, aircrafts, office buildings and residential houses.

Although the present invention has been described in detail and with particularity, it will be appreciated by those skilled in this art that changes and modifications can be made therein without departing from the scope and spirit of the invention.

What is claimed:

1. An electrically-controlled window-tinting apparatus comprising:
two sheets of glass;
an interchamber, said interchamber being formed between the sheets of glass;
a mixture of chemicals being located within the interchamber;
a variable inductor; and
a frequency oscillator;
whereby the frequency oscillator and the inductor control radiation within the interchamber to transform the chemicals into controllable visible light.

2. The window-tinting apparatus of claim 1 whereby the mixture of chemicals includes nitrogen gas, a liquid mixture of phosphors and an oxygen moisturizer.

3. The window-tinting apparatus of claim 1 whereby each sheet of glass is about 1/16″ to about ¼″ in thickness.

4. The window-tinting apparatus of claim 1 whereby the inductor and frequency oscillator are in series with one another.

5. The window-tinting apparatus of claim 1 whereby the interchamber acts as a fluorescent screen.

6. The window-tinting apparatus of claim 2 whereby the mixture of phosphors glow when impinged by the radiation.

7. The window-tinting apparatus of claim 2 whereby the mixture of phosphors transforms images made from invisible radiations into visible ultra-violet light that can change color.

8. The window-tinting apparatus of claim 1 whereby each radiation sequence is controlled by a separate inductor.

9. The window-tinting apparatus of claim 1 whereby the inductors are controlled by a single oscillator.

10. The window-tinting apparatus of claim 1 whereby the interchamber is ultra-thin.

11. The window-tinting apparatus of claim 1 whereby the radiation is a frequency of X-rays and/or gamma rays.

12. The window-tinting apparatus of claim 1 whereby color, tint, tone, shade, frost are controlled by the ionization of the chemicals.

13. The window-tinting apparatus of claim 1 whereby patterns are controlled by the ionization of the chemicals.

14. A method for electrically controlling window tints comprising the steps of:
providing two sheets of glass with an interchamber formed therebetween;
sealing a mixture of chemicals within the interchamber;
connecting a variable inductor and a frequency oscillator to the interchamber,
whereby the frequency oscillator and the inductor control radiation within the interchamber thereby transforming the chemicals into controllable visible light.

15. The method of claim 14 whereby the mixture of chemicals includes nitrogen gas, a liquid mixture of phosphors and an oxygen moisturizer.

16. The method of claim 14 whereby each sheet of glass is about 1/16″ to about ¼″ in thickness.

17. The method of claim 14 whereby the inductor and frequency oscillator are in series with one another.

18. The method of claim 14 whereby the interchamber acts as a fluorescent screen.

19. The method of claim 15 whereby the mixture of phosphors glow when impinged by the radiation.

20. The method of claim 15 whereby the mixture of phosphors transforms images made from invisible radiations into visible ultra-violet light that can change color.

21. The method of claim 14 whereby each radiation sequence is controlled by a separate inductor.

22. The method of claim 14 whereby the inductors are controlled by a single oscillator.

23. The window-tinting apparatus of claim 1 whereby the interchamber is ultra-thin.

24. The method of claim 14 whereby the radiation is a frequency of X-rays and/or gamma rays.

25. The method of claim 14 whereby color, tint, tone, shade, frost are controlled by the ionization of the chemicals.

26. The method of claim 14 whereby patterns are controlled by the ionization of the chemicals.
